(19) United States
(12) Patent Application Publication
(10) Pub. No.: US 2005/0237588 A1
(43) Pub. Date: Oct. 27, 2005

(54) Printing order receiving method and apparatus and frame extraction method and apparatus

(75) Inventors: Koichi Gohara, Kanagawa (JP); Hiroshi Murakami, Kanagawa (JP); Kei Yamaji, Kanagawa (JP); Hajime Araya, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/106,690

(22) Filed: Apr. 15, 2005

(30) Foreign Application Priority Data
Apr. 15, 2004 (JP) 2004-120444

(51) Int. Cl. G06F 15/00

(52) U.S. Cl. 358/538

(57) ABSTRACT

Still images which are materials of a photo movie are displayed on a monitor. One still image is selected by observing the monitor. A frame including the selected still image is extracted from the photo movie. The extracted frame or a scene including the extracted frame is displayed on the monitor. When the frame displayed on the monitor is designated, the frame is printed by a printer.

### BACKGROUND OF THE INVENTION

1. Field of the Invention

The present invention relates to a method and an apparatus for receiving a printing order for a frame in a photo movie and to a method and an apparatus for extracting a frame to be printed.

2. Description of the Related Art

A photo movie, as disclosed in Japanese Patent Laid-Open Publication No. 2003-283994, is an image sequence produced by graphically modifying still images on the basis of a scenario and editing the still images into a form just like a moving picture. In a photo movie producing apparatus, a user, on the basis of a scenario produced in accordance with the purpose of production, carries out selection of a still image and various types of modifying processing of the image such as transformation (enlargement, reduction, rotation, and the like), zooming, masking (cropping and synthesis), moving, combining sequences, and the like of the still image, to produce a photo movie.

Further, a printing ordering apparatus which prints each still images included in a frame by designating said frame while a photo movie is reproduced (see Japanese Patent Laid-Open Publication No. 2004-64285) is proposed. In such apparatus, each still image which is a material of the frame is designated from information indicating a position of reproduction of each frame.

However, in a printing ordering apparatus as described in Japanese Patent Laid-Open Publication No. 2004-64285, the whole part of the photo movie should be reproduced and displayed in order to designate the frame including the still image to be printed. Thus, a customer has to wait until the frame to be printed is reproduced and displayed, and designation of the frame including the still image takes a very long time.

### SUMMARY OF THE INVENTION

In view of the foregoing, an object of the present invention is to provide a method and an apparatus for receiving a printing order and a method and an apparatus for extracting a frame capable of extracting and designating a frame of a photo movie to be printed in a short length of time.

In order to achieve the above and other objects, in the present invention, a still image which is a material of the photo movie is displayed for selection of the still image. Also, in the present invention, the frame including the selected still images as the material is extracted from the photo movie, and the extracted frame or a scene including the extracted frame is displayed.

In the scenario, discerning information of the still images included in the frame and a time stamp of information of a position of the frame within the photo movie are stored in the scenario per each frame. Also, a time stamp of the frame which includes the selected still image as the material is obtained from the scenario on the basis of the discerning information of the selected still image, and the extraction of the frame is performed on the basis of the obtained time stamp.

Further, the still image, the scenario, and the photo movie are stored on the same recording medium, and the still image, the scenario, and the photo movie are read from the recording medium.

An apparatus for receiving a printing order of the present invention includes a display for displaying the still image which is the material of the photo movie, an operation device for selecting the still image included in the frame to be printed, a frame extractor for extracting the frame including the selected still image as the material from the photo movie, and a display controller for displaying on the display the extracted frame or the scene including the extracted frame.

According to the present invention, the frame whose material is the selected still image is extracted from the photo movie, the frame of the scene including the frame is displayed on the display, and the frame to be printed is designated. Therefore, designation of the frame can be performed in a short length of time.

### BRIEF DESCRIPTION OF THE DRAWINGS

The above objects and advantages of the present invention will become apparent to a person skilled in the art from the following detailed description of the preferred embodiments of the invention when read in conjunction with the accompanying drawings, in which:

FIG. 1 is a schematic view showing a constitution of a printing order receiving apparatus to which the present invention is applied;

FIG. 2 is an explanatory view showing a form of a scenario;

FIG. 3 is a view showing one example of a window displayed on a monitor in selecting an image;

FIG. 4A is a view showing one example of the window displayed on the monitor in designating a frame, showing an example in which a list of the frames is displayed;

FIG. 4B is a view showing one example of the window displayed on the monitor in designating the frame, showing an example in which a scene including the frame is displayed; and

FIG. 5 is a flow chart showing a procedure of the printing order receiving apparatus.

### DETAILED DESCRIPTION OF THE PREFERRED EMBODIMENT(S)

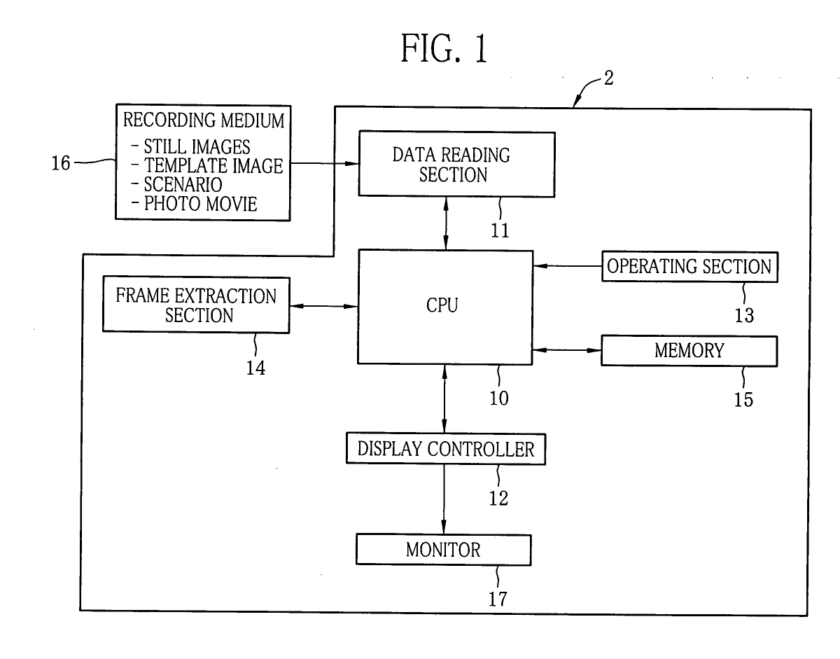

In FIG. 1, a printing order receiving apparatus 2, which the present invention is applied to, is controlled over by a CPU 10. A data reading section 11, a display controller 12, an operating section 13, a frame extraction section 14, and a memory 15 are connected to the CPU 10. The printing order receiving apparatus 2 is an apparatus for receiving a printing order of a frame of a photo movie or image sequence produced by editing (graphically modifying, combining, and the like) a still image according to a scenario, script or description file determining a form of displaying the still image.

The data reading section 11 reads the still images, a template image, the scenario, and the photo movie from a recording medium 16 such as DVD (Digital Versatile Disk) on which the still images, the template image, the scenario, and the photo movie are recorded. The data read by the data reading section 11 is stored in the memory 15. The still image includes a digital image obtained by capturing by imaging devices such as a digital camera, a cell-phone with camera, and the like, or a digital image obtained by photoelectrically reading an image recorded on a photographic film or a photographic paper. Further, the template image includes a background image and a mask image of the photo movie.

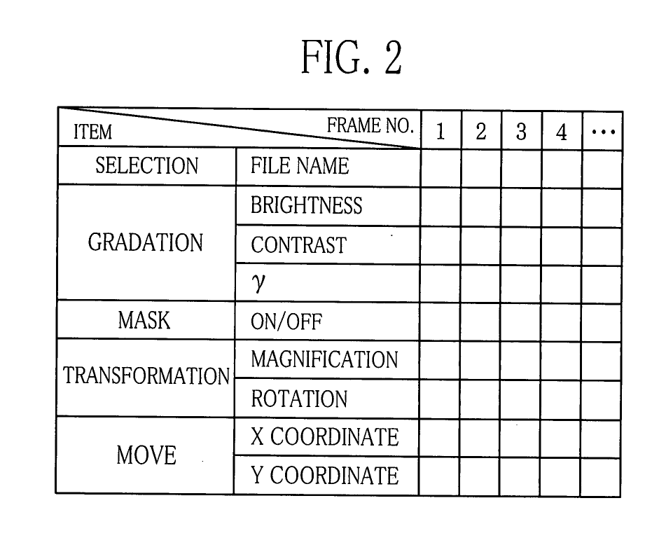

As shown in FIG. 2, the scenario has a format in which a file name (discerning information), a gradation correction value (brightness, contrast, and γ-correction value), presence or absence of masking, and various parameters such as a transformation parameter (ratio of enlargement and reduction, and rotation) and a moving parameter (X and Y coordinates) of the still image which is the material of the frame are designated per each frame. A frame rate of the photo movie is set at, for example, 60 frames per second.

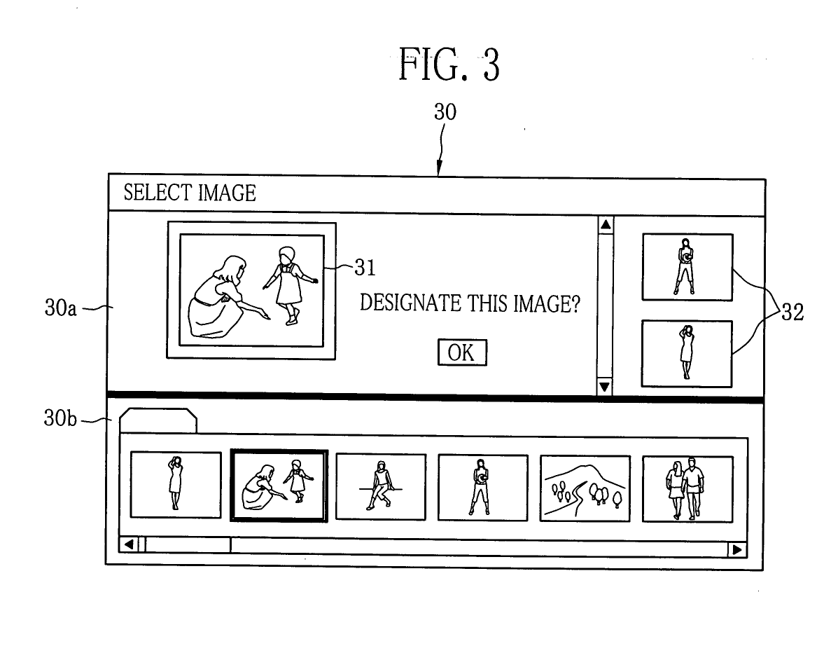

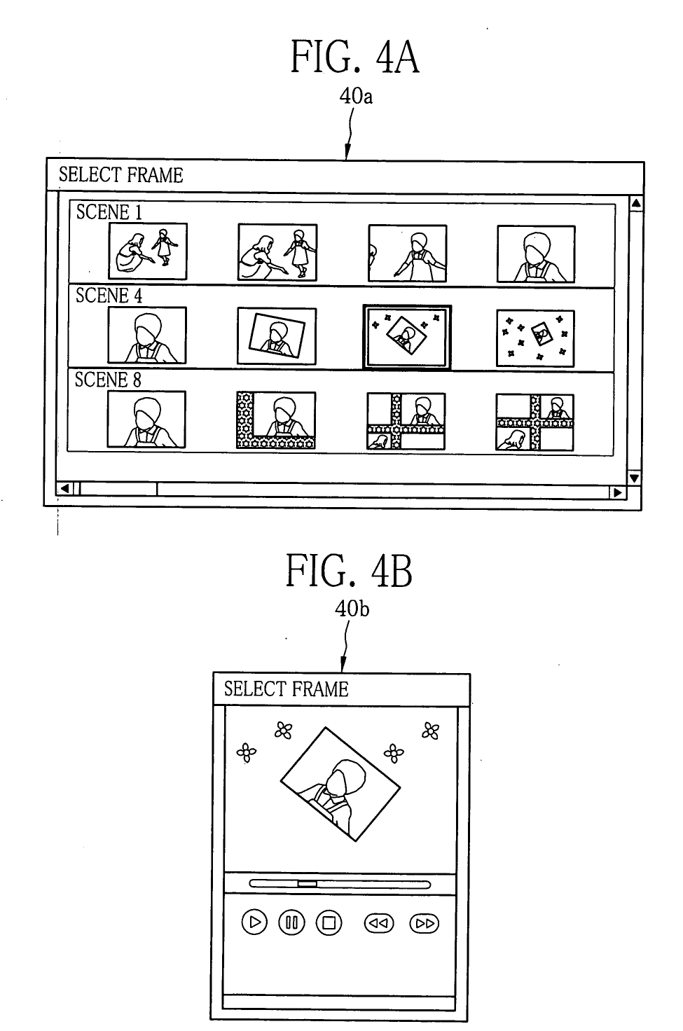

In FIG. 1, a monitor 17 is connected to the display controller 12. The display controller 12 performs display control of the monitor 17 according to a control instruction by the CPU 10. The monitor 17 displays various types of order menu screens and also displays the still image which is the material of the photo movie in designating the frame to be printed (see FIG. 3). Further, the monitor 17 displays the frame extracted by the frame extraction section 14 and a scene of the photo movie including the extracted frame (see FIG. 4).

The operating section 13 includes a keyboard, a mouse, a touch panel, and the like, and is operated for selecting the still image included in the frame to be printed, designating the frame to be printed, and inputting ordering information such as personal data of a customer, a print size (L-size, 2L-size, and the like), a number of prints to make, and a date and time of delivery of a printed product.

The frame extraction section 14, when the operating section 13 is operated, obtains from the scenario a time stamp (information indicating a position of a certain frame in the photo movie) of the frame whose material is the selected still image on the basis of the file name or discerning information of the selected still image. The frame including the selected still image is extracted on the basis of the obtained time stamp. The frame extraction section 14 transmits the result of extraction to the CPU 10. The time stamp is assigned to each frame, when the photo movie is produced, in association with a reproduction position while the photo movie is reproduced and displayed.

The memory 15 stores various types of programs and the data for operating the printing order receiving apparatus 2. Further, the memory 15 stores the various data read by the data reading section 11 from the recording medium 16. The CPU 10 reads the program and the data stored in the memory 15 from the memory 15 and controls the operation of each section, unit, and the like.

The CPU 10, after the various data is read by the data reading section 11, transmits to the display controller 12 the control instruction such that the read still image (including the template image) be displayed on the monitor 17. The display controller 12 makes the monitor 17 display a window 30 as shown in FIG. 3, for example, on the basis of the control instruction.

In the window 30, a list of thumbnail images of the still images which are the material of the photo movie is displayed in a lower section 30b of the window 30. Besides, in an upper section 30a of the window 30, the still image 31 to be selected by the operating section 13 and the still images 32 selected by previous selections before the still image 31 are displayed. The customer, while looking at the window 30, selects the still image included in the frame to be printed by operating the operating section 13 and by pressing an “OK” button.

Further, the CPU 10 transmits a control instruction such that the extracted frame or the scene of the photo movie including the extracted frame be displayed on the monitor 17, in accordance with the result of extraction of the frame transmitted from the frame extraction section 14. The display controller 12 makes the monitor 17 display, for example, a window 40a and a window 40b as shown in FIG. 4A or FIG. 4B, on the basis of the control instruction.

In FIG. 4A, groups of thumbnail images of the scene including the frame extracted by the frame extraction section 14 are displayed in the window 40a. On the other hand, in FIG. 4B, the frame extracted by the frame extraction section 14 is displayed in the window 40b. The customer, while looking at the window 40a or the window 40b, designates the frame to be printed by operating the operating section 13.

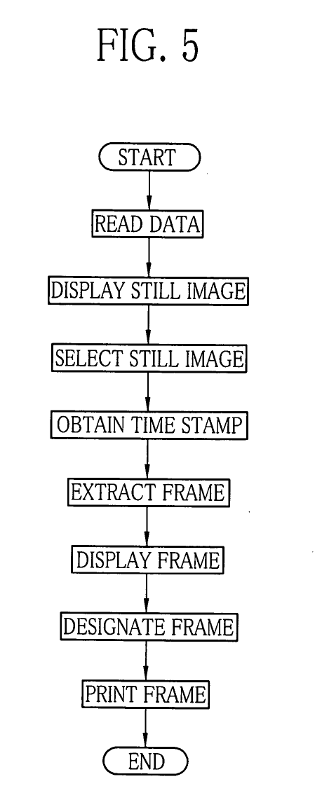

Next, an effect of the printing order receiving apparatus 2 having the above constitution will be explained by referring to the flowchart of FIG. 5. First, the still images (usually of 3,000,000 pixels), the template image, the scenario, and the photo movie stored on the recording medium 16 are read by the data reading section 11 and are stored in the memory 15.

After the various data is read, the control instruction such that the read still image be displayed on the monitor 17 is transmitted from the CPU 10 to the display controller 12. Thereby the thumbnail image of the still image included in the frame to be printed is displayed on the monitor 17, in a form like the window 30, for example.

When the window 30 is referred to and the operating section 13 is operated by the customer to select the still image included in the frame to be printed, the time stamp of the frame including the selected still image is obtained from the scenario by the frame extraction section 14, on the basis of the file name or discerning information of the selected still image. Then, on the basis of the time stamp, the frame including the selected still image is extracted.

The extracted frame or the scene of the photo movie including the extracted frame is displayed on the monitor 17. Thereby, the extracted frame or the scene of the photo movie including the extracted frame is displayed on the monitor 17, in a form like the window 40a or the window 40b, for example.

After the window 40a or the window 40b is referred to and the operating section 13 is operated by the customer, the frame to be printed is designated. The frame designated to be printed is printed by a printing apparatus (not shown), on the basis of ordering information inputted by the operating section 13. The pixel number of the frame in viewing the photo movie is 640×480 pixels. The pixel number of the frame in printing, for example L-size printing, is 2,024×1,536 pixels.

As mentioned above, because the still image which is the material of the photo movie is displayed when the customer designates the frame to be printed, the time taken for designating the frame can be remarkably shortened compared to the case where the whole part of the photo movie is reproduced in designating the frame.

In order to select the frame, it may be possible, instead of displaying the still image which is the material of the photo movie, to display a representative frame among frames formed on the basis of the information on special effects such as transformation (enlargement, reduction, rotation, and the like), zooming, masking (cropping and synthesis), moving, combining sequences, and the like, by obtaining such information from the scenario.

Further, in producing and editing the photo movie, a print candidate flag indicating the frame to be printed may be described in the scenario in advance. In addition, by extracting the face of a person in the still image using a well-known image recognition technology, the print candidate flag may be described in the scenario of the frame in which the face of the person is zoomed up, for example. The frame having the print candidate flag is retrieved and displayed. In this case also, the time taken in designating the frame can be further shortened.

In the above embodiment, explanation is made by referring for example to an embodiment in which the printing order receiving apparatus 2 is installed in a photo shop or a convenience store in town, however, the present invention is applicable also to an embodiment in which an order is received through a personal computer possessed by a customer via a communication network such as the Internet and the like.

Although the present invention has been fully described by way of the preferred embodiments thereof with reference to the accompanying drawings, various changes and modifications will be apparent to those having skill in this field. Therefore, unless otherwise these changes and modifications depart from the scope of the present invention, they should be construed as included therein.

1. A method of receiving a printing order of a frame in a photo movie, said photo movie being produced by editing still images according to a scenario determining a form of displaying, said method of receiving a printing order comprising the steps of:
displaying said still images which are materials of said photo movie;
selecting a still image from among said still images;
extracting at least one frame including said selected still image from said photo movie;
displaying said at least one extracted frame; and
designating a frame to be printed in said at least one displayed frame.

2. A method of receiving a printing order as recited in claim 1, wherein said still images and said frame are displayed in a thumbnail image form.

3. A method of receiving a printing order as recited in claim 2, wherein said at least one frame comprises said frames of one scene including said one frame.

4. A method of receiving a printing order as recited in claim 2, wherein discerning information for discerning said still image included in said frame and a time stamp of information of a position of said frame within said photo movie are assigned per each of said frames, and said discerning information and said time stamp are included in said scenario.

5. A method of receiving a printing order as recited in claim 4, wherein said extraction step obtains from said scenario said time stamp of said frame including said selected still image on the basis of said discerning information of said selected still images, and extracts said frame on the basis of said obtained time stamp.

6. A method of receiving a printing order as recited in claim 5, wherein said still images, said scenario, and said photo movie are stored on the same recording medium, said method further comprising the step of:
reading said still images, said scenario, and said photo movie from said recording medium.

7. An apparatus for receiving a printing order of a frame in a photo movie, said photo movie being produced by editing still images according to a scenario determining a form of displaying, said apparatus for receiving a printing order comprising:
a display for displaying said still images which are materials of said photo movie;
an operation device for selecting one still image from said still images;
a frame extraction section for extracting at least one frame whose materials are said selected still images from said photo movie;
a display controller for displaying said at least one frame on said display; and
a designating device for designating a frame to be printed in said at least one frame displayed on said display.

8. An apparatus for receiving a printing order as recited in claim 7, wherein said display displays said still images and said frame in a thumbnail image form.

9. An apparatus for receiving a printing order as recited in claim 8, wherein said at least one frame comprises said frames of one scene including said one frame.

10. An apparatus for receiving a printing order as recited in claim 8, wherein discerning information for discerning said still image included in said frame and a time stamp of information of a position of said frame within said photo movie are assigned per each of said frames, and said discerning information and said time stamp are included in said scenario.

11. An apparatus for receiving a printing order as recited in claim 10, wherein said frame extraction section obtains from said scenario said time stamp of said frame including said selected still image on the basis of said discerning information of said selected still images, and extracts said frame on the basis of said obtained time stamp.

12. An apparatus for receiving a printing order as recited in claim 10, wherein said still images, said scenario, and said photo movie are stored on the same recording medium, said apparatus further comprising:
a data reading section for reading said still images, said scenario, and said photo movie from said recording medium.

13. A method of extracting a frame to be printed in a photo movie, said photo movie being produced by editing still images according to a scenario determining a form of displaying, said method of extracting a frame comprising the steps of:
displaying said still images which are materials of said photo movie;
selecting a still image from said still images; and
extracting at least one frame whose materials are said selected still images from said photo movie.

14. A method of extracting a frame as recited in claim 13, further comprising the step of displaying said at least one extracted frame.

15. A method of extracting a frame as recited in claim 14, wherein said still images and said at least one extracted frame are displayed in a thumbnail image form.

16. A method of extracting a frame as recited in claim 15, wherein said at least one frame comprises said frames of one scene including said one frame.

17. A method of extracting a frame as recited in claim 15, wherein discerning information for discerning said still image included in said frame and a time stamp of information of a position of said frame within said photo movie are assigned per each of said frames, and said discerning information and said time stamp are included in said scenario.

18. A method of extracting a frame as recited in claim 17, wherein said extraction step obtains from said scenario said time stamp of said frame including said selected still images on the basis of said discerning information of said selected still images and extracts said frame on the basis of said obtained time stamp.

19. A method of extracting a frame as recited in, claim 18, wherein said still images, said scenario, and said photo movie are stored on the same recording medium, said method further comprising the step of:
reading said still images, said scenario, and said photo movie from said recording medium.

20. An apparatus for extracting a frame to be printed in a photo movie, said photo movie being produced by editing still images according to a scenario determining a form of displaying, said apparatus for extracting a frame comprising:
a display for displaying said still images which are materials of said photo movie;
an operation device for selecting one still image from said still images; and
a frame extraction section for extracting at least one frame including said selected still image from said photo movie.

21. An apparatus for extracting a frame as recited in claim 20, further comprising a display for displaying said at least one extracted frame.

22. An apparatus for extracting a frame as recited in claim 21, wherein said still images and said at least one extracted frame are displayed in a thumbnail image form.

23. An apparatus for extracting a frame as recited in claim 22, wherein discerning information for discerning said still image included in said frame and a time stamp of information of a position of said frame within said photo movie are assigned per each of said frames, and said discerning information and said time stamp are included in said scenario.

24. An apparatus for extracting a frame as recited in claim 23, wherein said frame extraction section obtains from said scenario said time stamp of said frame including said selected still image on the basis of said discerning information of said selected still images and extracts said frame on the basis of said obtained time stamp.

25. An apparatus for extracting a frame as recited in claim 24, wherein said still images, said scenario, and said photo movie are stored on the same recording medium, said apparatus further comprising:
a data reading section for reading said still images, said scenario, and said photo movie from said recording medium.
